(19) United States
(12) Patent Application Publication
(10) Pub. No.: US 2007/0102271 A1
(43) Pub. Date: May 10, 2007

(54) Switch having hot-key switching buttons and indicator means

(75) Inventor: Cheng-Sheng Chou, Taipei City (TW)

Correspondence Address: John G. Chupa;Law Offices of John Chupa & Associates, P.C., Suite 50, 28535 Orchard Lake Road, Farmington Hills, MI, 48334, US

(73) Assignee: JUNE-ON CO., LTD.

(21) Appl. No.: 11/493,881

(22) Filed: Jul. 26, 2006

(30) Foreign Application Priority Data
Nov. 4, 2005 (TW) 094219092

(51) Int. Cl. H01H 9/00

(52) U.S. Cl. 200/310

(57) ABSTRACT

A switch is disclosed to include a housing, a PC board, which is mounted inside the housing and has a control circuit, a face panel mounted on one the housing, a plurality of switching buttons respectively mounted in respective holes on the face panel and electrically coupled to the control circuit of the PC board for switching a respective hot-key, and a plurality of hot-key indicator lights respectively mounted in respective holes on the face panel and electrically coupled to the control circuit of the PC board for indicating the operation status of the switching buttons respectively.

### BACKGROUND OF THE INVENTION

1. Field of the Invention

The present invention relates to computer switches and more particularly, to a switch, which has switching buttons for switching respective hot-keys and hot-key indicator lights for indicating the operation status of the switching buttons so that the user knows the status of each hot-key that has been using.

2. Description of the Related Art

Commercial computer switches (such as KRM Switch, Video Switch, etc.) have switching buttons on the face panel for switching specific functions of the computer. Further, a computer user may use the keyboard of the computer to give a hot-key command. Further, various computer operation systems (Microsoft's Window 200, Window XP, Unix, Linux, Apple's MAC OS, etc.) and software systems (TELCOM, PC Anywhere, drawing software) are commercially available. In order to prevent a conflict between a hot-key command of the switch and a particular function key (for example, Ctrl+Alt, Ctrl+Shift, etc.) of the operation system or software system of the computer, multiple sets of hot-key commands (for example, <Ctrl><Ctrl>, <Caps Lock><Caps Lock>, Ctrl+Alt, etc.) may be provided for setting by the user.

However, the user may forget what hot-key has been set or is in operation, and may have to make several trials to make sure of the operating hot-key command through the OSD (On-Screen Display). This condition will cause a big inconvenience when the system allows multiple users or the system does not have an OSD.

### SUMMARY OF THE INVENTION

The present invention has been accomplished under the circumstances in view. It is the main object of the present invention to provide a switch, which has switching buttons for switching respective hot-keys and hot-key indicator lights for indicating the operation status of the switching buttons so that the user knows the status of each hot-key that has been using.

It is another object of the present invention to provide a switch, which allows the user to set hot-keys through the keyboard of the computer as well as through the respective switching buttons of the switch that correspond to respective hot-key indicator lights on the face panel of the switch.

It is still another object of the present invention to provide a switch, which allows the user to control the operation of the switching buttons and hot-key indicator lights to set hot-keys by means of an infrared/radio remote controller.

According to one embodiment of the present invention, the switch comprises a housing, the housing defining a receiving chamber; a printed circuit board mounted in the receiving chamber inside the housing, the printed circuit board having a control circuit; a face panel mounted on one side of the housing, the face panel having at least one first hole and at least one second hole; at least one switching button respectively mounted in the at least one first hole of the face panel and electrically coupled to the control circuit of the printed circuit board for switching a respective hot-key; and at least one hot-key indicator light respectively mounted in the at least one second hole of the face panel and electrically coupled to the control circuit of the printed circuit board for indicating the operation status of the at least one switching button respectively. Further, the control circuit of the printed circuit board has a wireless receiving circuit that can be an infrared receiving circuit or radio receiving circuit.

According to another embodiment of the present invention, the switch comprises a housing, the housing defining a receiving chamber; a printed circuit board mounted in the receiving chamber inside the housing, the printed circuit board having a control circuit; a face panel mounted on one side of the housing, the face panel having at least one hole; at least one switching button respectively mounted in the at least one hole of the face panel and electrically coupled to the control circuit of the printed circuit board for switching a respective hot-key; and display means mounted in the face panel and electrically coupled to the control circuit of the printed circuit board for indicating the operation status of the at least one switching button respectively. Further, the control circuit of the printed circuit board has a wireless receiving circuit that can be an infrared receiving circuit or radio receiving circuit.

### BRIEF DESCRIPTION OF THE DRAWINGS

FIG. 1 is a schematic drawing showing a switch according to one embodiment of the present invention.

FIG. 2 is a schematic drawing showing an alternate form of the switch according to the present invention.

FIG. 3 is a schematic drawing showing another alternate form of the switch according to the present invention.

FIG. 4 is a schematic drawing showing still another alternate form of the switch according to the present invention.

FIG. 5 is a schematic drawing showing still another alternate form of the switch according to the present invention.

### DETAILED DESCRIPTION OF THE INVENTION

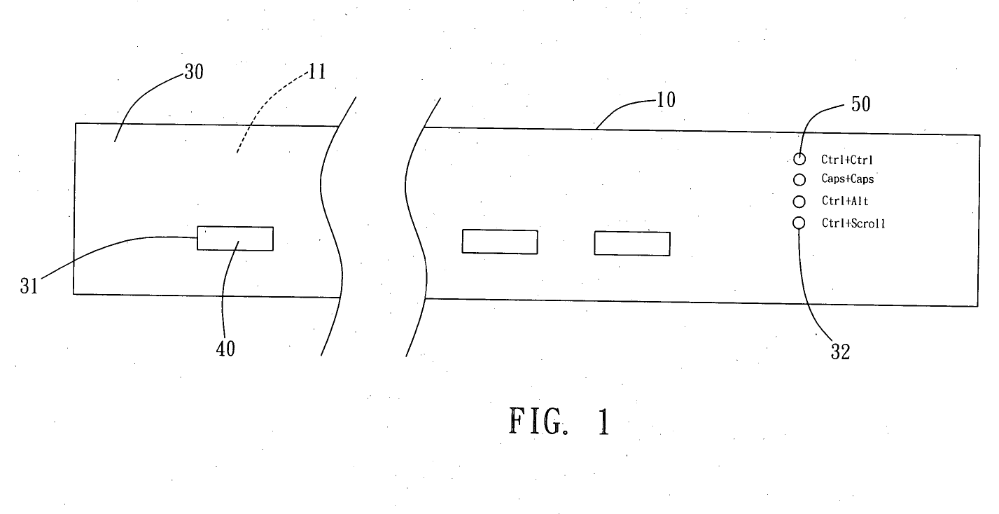

Referring to FIG. 1, a switch in accordance with the present invention is shown comprising a housing 10, a printed circuit board (not shown), a face panel 30, at least one switching button 40, and at least one hot-key indicator light 50. According to this embodiment, the switch comprises a plurality of switching buttons 40 and a plurality of hot-key indicator lights 50.

The housing 10 defines a front open side (not shown) and a receiving chamber 11 for accommodating the printed circuit board, the face panel 30, the switching buttons 40 and the hot-key indicator lights 50.

The printed circuit board is accommodated in the receiving chamber 11 inside the housing 10, having a control circuit (not shown) that controls the operation of the switching buttons 40 and the hot-key indicator lights 50.

The face panel 30 is mounted in the front open side of the housing 10 and firmly secured to the housing 10, having a plurality of first holes 31 and a plurality of second holes 32.

The switching buttons 40 are respectively mounted in the first holes 31 of the face panel 30 and electrically coupled to the control circuit of the printed circuit board inside the housing 10 for allowing the user to switch hot-keys or their combinations, for example, <Ctrl><Ctrl>, <Caps Lock><Caps Lock>, Ctrl+Alt, etc.

The hot-key indicator lights 50 are respectively mounted in the second holes 32 of the face panel 30 and electrically coupled to the control circuit of the printed circuit board inside the housing 10 for indicating the status of the switching buttons 40 subject to the control of the control circuit of the printed circuit board. The number of the hot-key indicator lights 50 corresponds to the number of the switching buttons 40. Preferably, the hot-key indicator lights 50 are respectively formed of a LED (Light Emitting Diode).

By means of the indication of the hot-key indicator lights 50 on the face panel 30, the user knows the operation status of the hot-keys. For example, when the <Ctrl><Ctrl> hot-key indicator light 50 is turned on, the user knows that the hot-key <Ctrl><Ctrl> has been using and will not input or define the same hot-key. Therefore, the invention eliminates the problem of forgetting the set multiple hot-keys or being unable to know the accurate hot-key due to change of the setting (by the user or another person).

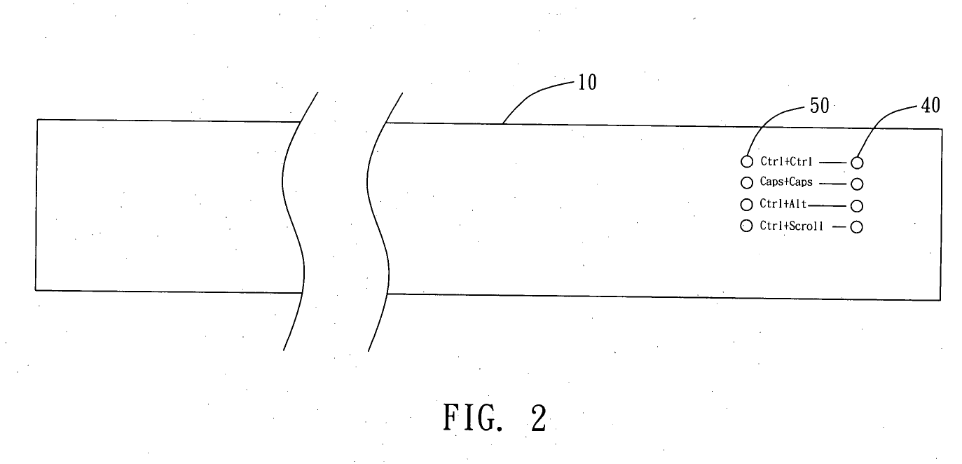

FIG. 2 shows an alternate form of the switch according to the present invention. According to this embodiment, the switching buttons 40 are respectively arranged at one side near the respective hot-key indicator lights 50 to save the space of the face panel 10 for other purposes.

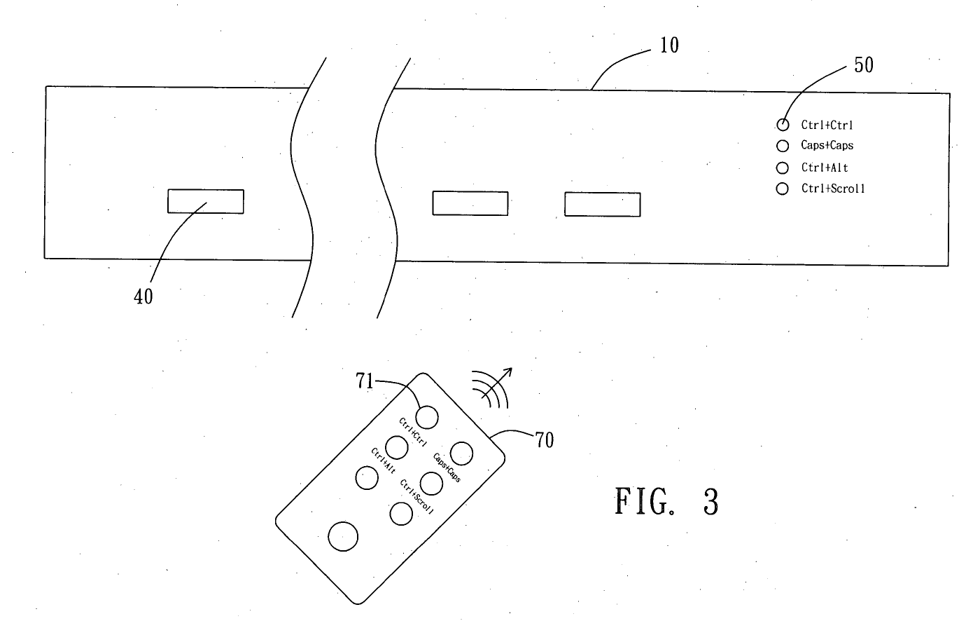

FIG. 3 shows another alternate form of the present invention. According to this embodiment, the switch is controllable by a remote controller 70, i.e., the control circuit of the switch comprises a wireless receiving circuit (not shown) adapted to receive wireless signals from the remote controller 70 for controlling the operation of the switching buttons 40 and the hot-key indicator lights 50. The remote controller 70 has hot-key operating buttons 71. According to this embodiment, the wireless receiving circuit can be an infrared receiving circuit or RF receiving circuit.

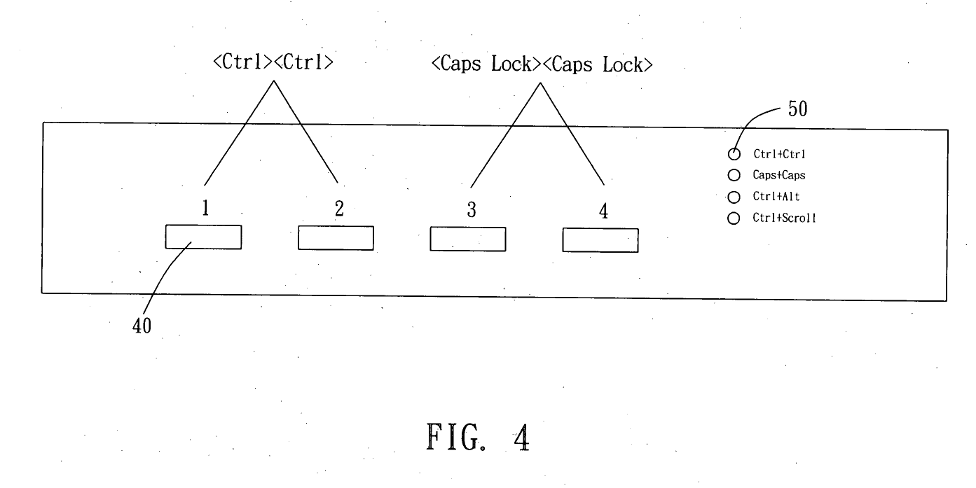

FIG. 4 shows still another alternate form of the present invention. According to this embodiment, the switching buttons 40 are arranged into sets for the switching of different hot-keys. For example, when the first and second switching buttons 40 are simultaneously pressed, the corresponding hot key <Ctrl> <Ctrl> is switched on, and the corresponding <Ctrl><Ctrl> hot-key indicator light 50 is turned on; when the third and fourth switching buttons 40 are simultaneously pressed, the corresponding hot key <Caps Lock><Caps Lock> is switched on, and the corresponding <Caps Lock><Caps Lock> hot-key indicator light 50 is turned on.

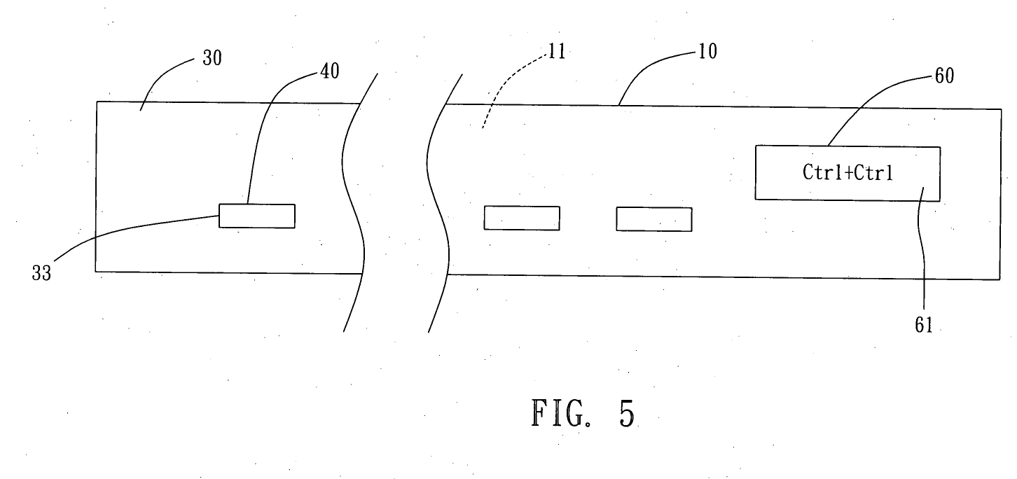

FIG. 5 shows still another alternate form of the present invention. According to this embodiment, the switch comprises a housing 10, a printed circuit board (not shown), a face panel 30, a plurality of switching buttons 40, and a display 60.

The housing 10 defines a front open side (not shown) and a receiving chamber 11 for accommodating the printed circuit board, the face panel 30, and the switching buttons 40.

The printed circuit board is accommodated in the receiving chamber 11 inside the housing 10, having a control circuit (not shown) that controls the operation of the switching buttons 40 and the display 60.

The face panel 30 is mounted in the front open side of the housing 10 and firmly secured to the housing 10, having a plurality of holes 33.

The switching buttons 40 are respectively mounted in the holes 33 of the face panel 30 and electrically coupled to the control circuit of the printed circuit board inside the housing 10 for allowing the user to switch hot-keys or their combinations, for example, <Ctrl><Ctrl>, <Caps Lock><Caps Lock>, Ctrl+Alt, etc.

The display 60 is, for example, a LCD (Liquid Crystal Display) that is controlled by the control circuit of the printed circuit board to display a hot-key sign 61, for example, the hot-key sign Ctrl+Ctrl corresponding to one of the switching buttons 40 that is pressed by the user.

Therefore, by means of the indication of the displayed hot-key sign 61 on the display 60, the user knows the operation status of the respective hot-key. For example, when the hot-key sign 61 of <Ctrl><Ctrl> is displayed on the display 60, the user knows that the hot-key<Ctrl><Ctrl> has been using. Therefore, this embodiment eliminates the problem of forgetting the set multiple hot-keys or being unable to know the accurate hot-key due to change of the setting (by the user or another person). Further, the features of the embodiments shown in FIGS. 2 and 4 may be combined to the embodiment shown in FIG. 5.

As indicated above, the switch has switching buttons on the face panel for switching respective hot-keys and indicator means for showing the operation status of the set hot-keys. Therefore, the user knows the set hot-keys and their operation status.

A prototype of switch has been constructed with the features of FIGS. 1-5. The switch functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A switch system comprising:
a housing, said housing defining a receiving chamber;
a printed circuit board mounted in said receiving chamber inside said housing, said printed circuit board having a control circuit;
a face panel mounted on one side of said housing, said face panel having at least one first hole and at least one second hole;
at least one switching button respectively mounted in said at least one first hole of said face panel and electrically coupled to said control circuit of said printed circuit board for switching a respective hot-key; and
at least one hot-key indicator light respectively mounted in said at least one second hole of said face panel and electrically coupled to said control circuit of said printed circuit board for indicating said operation status of said at least one switching button respectively.

2. The switch as claimed in claim 1, wherein said amount of said at least one hot-key indicator light corresponds to said amount of said at least one switching button.

3. The switch as claimed in claim 2, wherein said at east one switching button includes a plurality of switching buttons arranged in sets for switching a respective hot-key.

4. The switch as claimed in claim 1, wherein said at least one hot-key indicator light each is respectively formed of a light emitting diode.

5. The switch as claimed in claim 1, wherein said control circuit of said printed circuit board comprises a wireless receiving circuit adapted to receive wireless signals from a remote controller to control said operation of said at least one switching button and said at least one hot-key indicator light.

6. The switch as claimed in claim 5, wherein said wireless receiving circuit is an infrared or a radio receiving circuit

7. A switch comprising:
a housing, said housing defining a receiving chamber;
a printed circuit board mounted in said receiving chamber inside said housing, said printed circuit board having a control circuit;
a face panel mounted on one side of said housing, said face panel having at least one hole;
at least one switching button respectively mounted in said at least one hole of said face panel and electrically coupled to said control circuit of said printed circuit board for switching a respective hot-key; and
display means mounted in said face panel and electrically coupled to said control circuit of said printed circuit board for indicating said operation status of said at least one switching button respectively.

8. The switch as claimed in claim 7, wherein said display means is a liquid crystal display for displaying hot-key signs corresponding to said switching buttons.

9. The switch as claimed in claim 7, wherein said control circuit of said printed circuit board comprises a wireless receiving circuit adapted to receive wireless signals from a remote controller to control said operation of said at least one switching button and said display means.

10. The switch as claimed in claim 8, wherein said wireless receiving circuit is an infrared receiving circuit.

11. The switch as claimed in claim 10, wherein said wireless receiving circuit is a radio receiving circuit.
